(19) United States
(12) Patent Application Publication
(10) Pub. No.: US 2023/0393350 A1
(43) Pub. Date: Dec. 7, 2023

(54) OPTICAL FIBER RIBBON AND METHOD FOR MANUFACTURING OPTICAL FIBER RIBBON

(71) Applicant: SUMITOMO ELECTRIC INDUSTRIES, LTD., Osaka (JP)

(72) Inventors: Akihisa WATANABE, Osaka (JP); Fumiaki SATO, Osaka (JP)

(21) Appl. No.: 18/245,043

(22) PCT Filed: Sep. 13, 2021
(86) PCT No.: PCT/JP2021/033518

§ 371 Date: Mar. 13, 2023

(30) Foreign Application Priority Data
Sep. 14, 2020 (JP) 2020-153898

(51) Int. Cl. G02B 6/38; G02B 6/44

(52) U.S. Cl. CPC G02B 6/3885; G02B 6/4403

(57) ABSTRACT

An optical fiber ribbon includes a plurality of optical fibers arranged in parallel, a coupling resin for coupling the plurality of optical fibers to each other; and a bridge portion formed of the coupling resin, in which the optical fibers are arranged such that a side surface of one optical fiber is spaced apart from or brought into contact with a side surface of another optical fiber adjacent thereto, the bridge portion is provided between the optical fibers arranged so as to be spaced apart from each other, an outer diameter of the optical fibers is 185 μm or more and 195 μm or less, and an average distance between centers of the optical fibers is 220 μm or more and 280 μm or less.

### TECHNICAL FIELD

The present disclosure relates to an optical fiber ribbon and a method for manufacturing an optical fiber ribbon.

This application claims priority based on Japanese Patent Application No. 2020-153898 filed on Sep. 14, 2020, the contents of which are incorporated herein by reference in its entirety.

### BACKGROUND ART

Patent Literature 1 describes an optical fiber ribbon having a structure in which optical fibers are spaced apart from each other so as not to come into contact with each other, and bridge portions formed of coupling resin are provided between the optical fibers. Patent Literatures 2 and 3 describe an intermittently connected optical fiber ribbon in which a gap is provided between adjacent optical fibers with a small diameter of 220 μm or less such that the distance between centers of the optical fibers is about 250 μm.

### CITATION LIST

### Patent Literature

Patent Literature 1: JP2010-117592A
Patent Literature 2: JP2015-052704A
Patent Literature 3: JP2013-088617A

### SUMMARY OF INVENTION

### Solution to Problem

In order to achieve the object of the present disclosure, an optical fiber ribbon according to an aspect of the present disclosure includes
a plurality of optical fibers arranged in parallel, a coupling resin for coupling the plurality of optical fibers, and a bridge portion formed of the coupling resin, in which
the optical fibers are arranged such that a side surface of one optical fiber is spaced apart from or brought into contact with a side surface of another optical fiber adjacent to the one optical fiber,
the bridge portion is provided between the optical fibers arranged so as to be spaced apart from each other,
an outer diameter of the optical fiber is 185 μm or more and 195 μm or less, and
an average distance between centers of the optical fibers is 220 μm or more and 280 μm or less.

Further, a method for manufacturing an optical fiber ribbon according to an aspect of the present disclosure includes
arranging a plurality of optical fibers having an outer diameter of 185 μm or more and 195 μm or less in parallel,
arranging the plurality of optical fibers in parallel such that a side surface of one optical fiber is spaced apart from or brought into contact with a side surface of another optical fiber adjacent thereto, passing the plurality of optical fibers through a die with an average distance between centers of the optical fibers of 220 μm or more and 280 μm or less, and coating a coupling resin on outer peripheries of the spaced-apart portions and the plurality of optical fibers in contact, and
curing the coupling resin to provide a bridge portion between the optical fibers arranged so as to be spaced apart from each other.

### BRIEF DESCRIPTION OF DRAWINGS

FIG. 1 is a cross-sectional view showing an optical fiber ribbon according to a first embodiment.

FIG. 2 is a schematic diagram showing relationship between a pitch of optical fiber ribbons of Reference Example 1 and V grooves of a fusion splicer in a fusion process.

FIG. 3 is a schematic diagram showing relationship between a pitch of optical fiber ribbons of Reference Example 2 and the V grooves of the fusion splicer in the fusion process.

FIG. 4 is a schematic diagram showing relationship between a pitch of the optical fiber ribbons according to the present embodiment and the V grooves of the fusion splicer in the fusion process.

FIG. 5 is a diagram provided to explain a method for manufacturing an optical fiber ribbon according to the present embodiment.

FIG. 6 is a cross-sectional view of an optical fiber cable using the optical fiber ribbon according to the present embodiment.

FIG. 7 is a plan view showing an optical fiber ribbon according to a second embodiment.

FIG. 8 is a cross-sectional view showing an optical fiber ribbon according to a third embodiment.

### DESCRIPTION OF EMBODIMENTS

### Problems to be Solved by the Present Disclosure

When the optical fibers are arranged without gaps in the optical fiber ribbon using optical fibers with a small diameter of 220 μm or less, the distance between centers of adjacent optical fibers is small, in which case it is difficult to fit the optical fibers in the V grooves of the related fusion splicer.

For this reason, a configuration like the optical fiber ribbon described in Patent Literature 1 can be conceived, for example, in which the optical fibers are arranged apart from each other so as not to come into contact with each other and a bridge portion formed of a coupling resin is provided between the optical fibers. However, since the pitch of the V grooves in the related fusion splicer is 250 μm, when the optical fiber ribbon is adapted to this pitch of the V grooves, there are situations where the width of the bridge portion is narrowed, resulting in insufficient flexibility of the optical fiber ribbon. Since the optical fiber ribbon with the insufficient flexibility is hardly deformable, it is difficult to implement high-density mounting of the optical fiber cable.

Meanwhile, Patent Literatures 2 and 3 describe an intermittently connected optical fiber ribbon in which a gap is provided between adjacent optical fibers with a small diameter of 220 μm or less such that the distance between centers of the optical fibers is about 250 μm. However, there are situations where it is difficult to manufacture the intermittently connected optical fiber ribbon using the optical fibers with the small diameter as described above while keeping the gaps between the optical fibers constant and perform intermittent processing in the longitudinal direction at high speed and with high accuracy.

An object of the present disclosure is to provide an optical fiber ribbon that is easily mounted on V grooves with a pitch of 250 μm in a related fusion splicer and is suitable for high-density mounting using an optical fiber with a small diameter of 195 μm or less, and a method for manufacturing the optical fiber ribbon.

### Advantageous Effects of Invention

According to this disclosure, it is possible to provide an optical fiber ribbon that is easily mounted on a V groove with a pitch of 250 μm in a related fusion splicer and is suitable for high-density mounting using an optical fiber with a small diameter of 195 μm or less, and a method for manufacturing the optical fiber ribbon.

### DESCRIPTION OF EMBODIMENT OF THE PRESENT DISCLOSURE

First, embodiments of the present disclosure will be listed and described.

An optical fiber ribbon according to an aspect of the present disclosure includes:
(1) a plurality of optical fibers arranged in parallel, a coupling resin for coupling the plurality of optical fibers to each other, and a bridge portion formed of the coupling resin, in which
the optical fibers are arranged such that a side surface of one optical fiber is spaced apart from or brought into contact with a side surface of another optical fiber adjacent to the one optical fiber,
the bridge portion is provided between the optical fibers arranged so as to be spaced apart from each other,
an outer diameter of the optical fiber is 185 μm or more and 195 μm or less, and
an average distance between centers of the optical fibers is 220 μm or more and 280 μm or less.

According to this configuration, when using the optical fiber with a small diameter of 185 μm or more and 195 μm or less, by adjusting the width of the bridge portion, it is possible to easily mount the optical fiber on the V grooves with a pitch of 250 μm in the related fusion splicer. In addition, since the flexibility of the optical fiber ribbon can be increased, when mounting the optical fiber ribbon on the optical fiber cable, the optical fiber ribbon can be rolled for example, and be suitable for high-density mounting.
(2) The number of optical fibers arranged in contact is N, where, N may be a multiple of two.
(3) The coupling resin may have a Young's modulus of 0.5 MPa or more and 200 MPa or less at room temperature.

According to this configuration, the optical fiber ribbon has an appropriate range of rigidity. As a result, the optical fiber ribbon has appropriate flexibility.
(4) The optical fiber ribbon may include split portions along a longitudinal direction thereof, which are intermittently formed in the bridge portion.

According to this configuration, it is possible to further improve the flexibility of the optical fiber ribbon.
(5) The coupling resin may include a silicone-based release agent.

According to this configuration, it is possible to decrease the coefficient of friction of the coupling resin. As a result, when a plurality of optical fiber ribbons having the configuration described above are mounted on an optical fiber cable, each optical fiber ribbon can be easily moved in the longitudinal direction. Therefore, an increase in transmission loss in the optical fiber cable can be suppressed.
(6) The peeling strength between an outermost layer of the optical fiber and the coupling resin may be less than 0.1 N/mm.

According to this configuration, the coupling resin can be easily peeled off from the outermost layer of the optical fiber.
(7) The optical fiber may include a glass fiber, a first coating layer covering the periphery of the glass fiber, and a second coating layer covering the periphery of the first coating layer, in which
the second coating layer may include a cured product of a resin composition including a base resin including a urethane acrylate oligomer or urethane methacrylate oligomer, a monomer having a phenoxy group, a photopolymerization initiator and a silane coupling agent, and hydrophobic inorganic oxide particles, and
content of the inorganic oxide particles may be 1% by mass or more and 45% by by mass or less with respect to a total amount of the resin composition.

According to this configuration, the lateral pressure resistance of the optical fiber is enhanced. Therefore, it is possible to suppress an increase in transmission loss when the optical fibers are mounted on the optical fiber cable, making it more suitable for high-density mounting of the optical fiber ribbons.
(8) The optical fiber may have a bending loss of 0.5 dB or less at a wavelength of 1550 nm with a bending diameter of φ15 mm×1 turn, and 0.1 dB or less with a bending diameter of φ20 mm×1 turn.

According to this configuration, lateral pressure characteristics can be improved, and low temperature loss characteristics can be improved.

Further, a method for manufacturing an optical fiber ribbon according to an aspect of the present disclosure includes
(9) arranging a plurality of optical fibers having an outer diameter of 185 μm or more and 195 μm or less in parallel,
arranging the plurality of optical fibers in parallel such that a side surface of one optical fiber is spaced apart from or brought into contact with a side surface of another optical fiber adjacent thereto, passing the plurality of optical fibers through a die with an average distance between centers of the optical fibers of 220 μm or more and 280 μm or less, and coating a coupling resin on outer peripheries of the spaced-apart portions and the plurality of optical fibers in contact, and
curing the coupling resin to provide a bridge portion between the optical fibers arranged so as to be spaced apart from each other.

According to this method, it is possible to use an optical fiber with a small diameter of 185 μm or more and 195 μm or less and manufacture an optical fiber ribbon that is easily mounted on V grooves with a pitch of 250 μm of the related fusion splicer and is suitable for high-density mounting.

### Details of Embodiments of the Present Disclosure

Specific examples of an optical fiber ribbon and a method for manufacturing the optical fiber ribbon according to an embodiment of the present disclosure will be described below with reference to the drawings. In addition, the disclosure is not limited to these examples only, but is intended to be indicated by the claims, and includes all modifications within the scope and meaning equivalent to the claims.

### First Embodiment

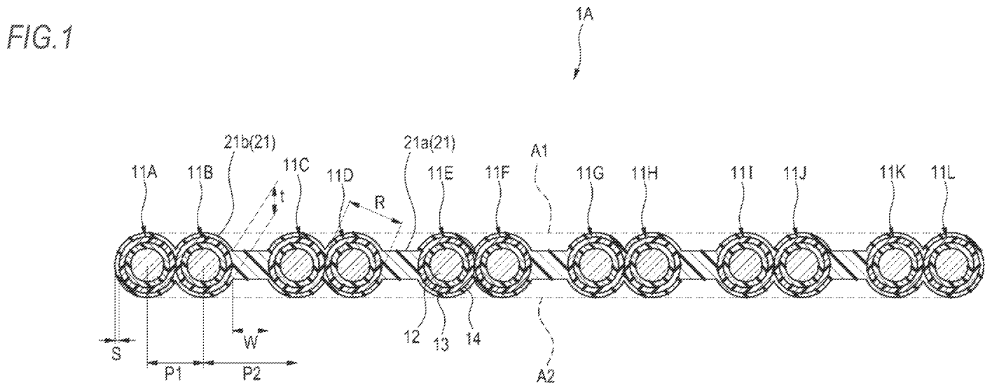

FIG. 1 is a cross-sectional view showing an optical fiber ribbon 1A according to a first embodiment.

As shown in FIG. 1, the optical fiber ribbon 1A includes a plurality (twelve, in this example) of optical fibers 11 (11A to 11L, in this example) arranged in parallel. The twelve optical fibers 11A to 11L are arranged such that, in every N fibers, a side surface of one optical fiber is spaced apart from or brought into contact with a side surface of another optical fiber adjacent thereto. In this example, the optical fibers 11A to 11L are arranged such that, in every two fibers, repeatedly, the side surface of one optical fiber is at a certain distance apart from and then brought into contact with the side surface of the other optical fiber adjacent thereto. It is to be noted that N may be a multiple of two. The twelve optical fibers 11A to 11L arranged in parallel are collectively connected with a coupling resin 21 as a whole.

The coupling resin 21 is provided between the two optical fibers 11 so as to fill the gap between the optical fibers 11 arranged at a certain distance from each other, and also provided around the optical fibers 11 to cover the optical fibers 11. The coupling resin 21 provided between the optical fibers 11 forms a bridge portion 21a that bridges the adjacent optical fibers 11. In addition, the coupling resin 21 provided around the optical fibers 11 other than between the optical fibers 11 connected by the bridge portion 21a forms an outer circumference coating portion 21b that covers the outer circumference of the optical fibers 11. That is, the optical fiber ribbon 1A is a bridge-type optical fiber ribbon having the bridge portion 21a between predetermined number of optical fibers 11 (every two fibers, in this example) that are in a state such that a side surface of an optical fiber is spaced apart from a side surface of another optical fiber adjacent thereto.

In the optical fiber ribbon 1A, for example, when M is an even number, the bridge portion 21a is provided between the (M)th optical fiber and the (M+1)th optical fiber from the left end. In this example, the bridge portion 21a is provided between the optical fibers 11B and 11C, between the optical fibers 11D and 11E, between the optical fibers 11F and 11G, between the optical fibers 11H and 11I, and between the optical fibers 11J and 11K.

The thickness t of the bridge portion 21a (the thickness in the direction orthogonal to the parallel direction of the optical fibers) is thinner than the sum of the outer diameter R of the optical fiber 11 and the thickness s of the outer circumference coating portion 21b. In addition, the bridge portion 21a is formed such that the position of an upper end of the bridge portion 21a does not exceed the position of a dashed line A1 connecting the upper ends of the outer circumference coating portions 21b applied around the optical fibers 11. Further, the bridge portion 21a is formed such that the position of a lower end of the bridge portion 21a does not exceed the position of a dashed line A2 connecting the lower ends of the outer circumference coating portions 21b. In this example, the bridge portion 21a is formed so as to connect approximately central portions of the adjacent optical fibers 11 to each other.

The coupling resin 21 forming the bridge portion 21a and the outer circumference coating portion 21b has a Young's modulus of 0.5 MPa or more and 200 MPa or less at room temperature (for example, 23° C.). For example, the coupling resin 21 includes an ultraviolet curable resin, a thermosetting resin, or the like. Further, it is preferable that the adhesion between the outermost layer of the optical fiber 11 and the coupling resin 21 is small, and for example, the coupling resin 21 may be formed of a resin including a silicone-based release agent. By including the silicone-based release agent in the coupling resin 21, the adhesion is reduced. As a result, the peelability of the coupling resin 21 is improved, thereby facilitating the work of separating the optical fibers 11A to 11L. In addition, since the coefficient of friction of the coupling resin 21 is smaller than that of a resin that does not include a silicone-based release agent, for example, when a plurality of optical fiber ribbons 1A are mounted on an optical fiber cable, each optical fiber ribbon 1A is easily moved in the longitudinal direction. Therefore, when mounted in an optical fiber cable, the optical fiber ribbon 1A can suppress an increase in transmission loss in a low-temperature environment for example. Examples of an index of the adhesion between the outermost layer of the optical fiber 11 and the coupling resin 21 include a peeling strength, which is the force per unit length required to peel off the coupling resin 21 from the outer peripheral surface of the optical fiber 11. In order to cause peeling, it is desirable that the peeling strength between the outermost layer of the optical fiber 11 and the coupling resin 21 is less than 0.1 N/mm.

The peeling strength between the outer peripheral surface of the optical fiber 11 and the coupling resin 21 is measured as follows.

In the optical fiber ribbon 1A, the coupling resin 21 is severed at both ends of the optical fiber 11 in the width direction with a knife or a razor. As a result, the coupling resin 21 is separated into upper and lower parts, and one of them is held and pulled at a speed of 100 mm/min in the longitudinal direction and direction perpendicular (at 90 degree) to the width direction of the optical fiber 11, and the tensile force at that time is measured. The measured tensile force and the length of the peeled coupling resin 21 are converted into peeling strength per unit length.

The optical fiber 11 includes a glass fiber 12 including a fiber and a clad, and two coating layers 13 and 14 covering the circumference of the glass fiber 12, for example. The first coating layer 13, which is the inner coating layer of the two coating layers, is formed of a cured primary resin. In addition, the second coating layer 14, which is the outer coating layer of the two coating layers, is formed of a cured secondary resin. It is to be noted that the optical fiber 11 may include a colored layer on the outer periphery of the second coating layer 14.

A soft resin having a relatively low Young's modulus is used as a buffer layer for the primary resin forming the first coating layer 13 contacting the glass fiber 12. A hard resin having a relatively high Young's modulus is used as a protective layer for the secondary resin forming the second coating layer 14. The cured product of the secondary resin has a Young's modulus of 900 MPa or higher, preferably 1000 MPa or higher, and more preferably 1500 MPa or higher at room temperature (for example, 23° C.).

The secondary resin that forms the second coating layer 14 is preferably a resin composition including a base resin including a urethane acrylate oligomer or urethane methacrylate oligomer, a monomer having a phenoxy group, a photopolymerization initiator and a silane coupling agent, and hydrophobic inorganic oxide particles. The content of the inorganic oxide particles in the resin composition is 1% by mass or more and 45% by mass or less with respect to the total amount of the resin composition.

Hereinafter, acrylates or methacrylates corresponding thereto are referred to as (meth)acrylates.

For the urethane (meth)acrylate oligomer, an oligomer obtained by reacting a polyol compound, a polyisocyanate compound, and a hydroxyl group-including (meth)acrylate compound can be used. For example, this oligomer can be obtained by reacting polypropylene glycol having a molecular weight of 4000, isophorone diisocyanate, hydroxyethyl acrylate and methanol, and the like.

A (meth)acrylate compound having a phenoxy group can be used as the monomer having a phenoxy group. For example, the monomer having a phenoxy group is nonylphenol EO-modified acrylate (trade name “Aronix M-113” manufactured by Toagosei Co., Ltd.) and the like.

For the photopolymerization initiator, it can be appropriately selected from the known radical photopolymerization initiators and used, and for example, the photopolymerization initiator is 2,4,6-trimethylbenzoyldiphenylphosphine oxide.

The silane coupling agent is not particularly limited as long as it does not interfere with curing of the resin composition. For example, the silane coupling agent is 3-mercaptopropyltrimethoxysilane and the like.

The hydrophobic inorganic oxide particles have a hydrophobic group introduced into the surface of the inorganic oxide particles. The inorganic oxide particles are silica particles, for example. The hydrophobic group may be a reactive group such as a (meth)acryloyl group and a vinyl group, or a non-reactive group such as a hydrocarbon group (for example, alkyl group) and an aryl group (for example, phenyl group).

By blending the inorganic oxide particles into the secondary resin that forms the second coating layer 14, the lateral pressure characteristics of the optical fiber 11 are improved. The primary resin and the secondary resin that form the first coating layer 13 are formed of an ultraviolet curable resin, a thermosetting resin, or the like, for example. In addition, the optical fiber 11 preferably has a bending loss of 0.5 dB or less at a wavelength of 1550 nm with a bending diameter of φ15 mm×1 turn, and a bending loss of 0.1 dB or lower with a bending diameter of φ20 mm×1 turn, which corresponds to ITU-TG.657A2. Using these optical fibers, it is possible to improve the lateral pressure characteristics, and improve the low-temperature loss characteristics.

In the optical fiber ribbon 1A formed as described above, the outer diameter R of the optical fiber 11 (11A to 11L) is 185 μm or more and 195 μm or less. For example, when the outer diameter R of each optical fiber 11 (11A to 11L) is 185 μm, the distance P1 between centers of the optical fibers 11 in contact with each other is approximately 185 μm. In this case, the optical fiber ribbon 1A is formed such that the distance P2 between centers of the optical fibers 11 spaced apart from each other by a predetermined distance is approximately 315 μm. Therefore, in the optical fiber ribbon 1A, the average distance P ((P1+P2)/2) between the centers of the adjacent optical fibers 11 is 220 μm or more and 280 μm or less. In this example, the width W of the bridge portion 21a (the width in the same direction as the parallel direction of the optical fibers 11) is calculated by W=P2−P1. Therefore, the width W of the bridge portion 21a is approximately 130 μm. Moreover, the thickness s of the outer circumference coating portion 21b is approximately 10 μm. Furthermore, the thickness t of the bridge portion 21a (thickness in the direction orthogonal to the parallel direction of the optical fibers) is approximately 90 μm, for example. By setting the thickness t of the bridge portion 21a to approximately 90 μm, it is possible to reduce the cross-sectional area of the optical fiber ribbon 1A, and also prevent the coating crack of the coupling resin 21 at the boundary between the bridge portion 21a and the outer circumference coating portion 21b.

That is, in FIG. 1, the optical fiber ribbon 1A is formed such that the distance P1 between centers of the optical fiber ribbons 11A and 11B is approximately 185 μm, the distance P2 between centers of the optical fiber ribbons 11B and 11C is approximately 315 μm, and the width W of the bridge portion 21a provided between the optical fibers 11B and 11C is approximately 130 μm.

In addition, although the number of fibers of the optical fiber ribbon 1A is 12 fibers in this example, embodiments are not limited thereto. The number of fibers of the optical fiber ribbon 1A is preferably a multiple of 4, and may be 24 fibers, 48 fibers, or the like, for example.

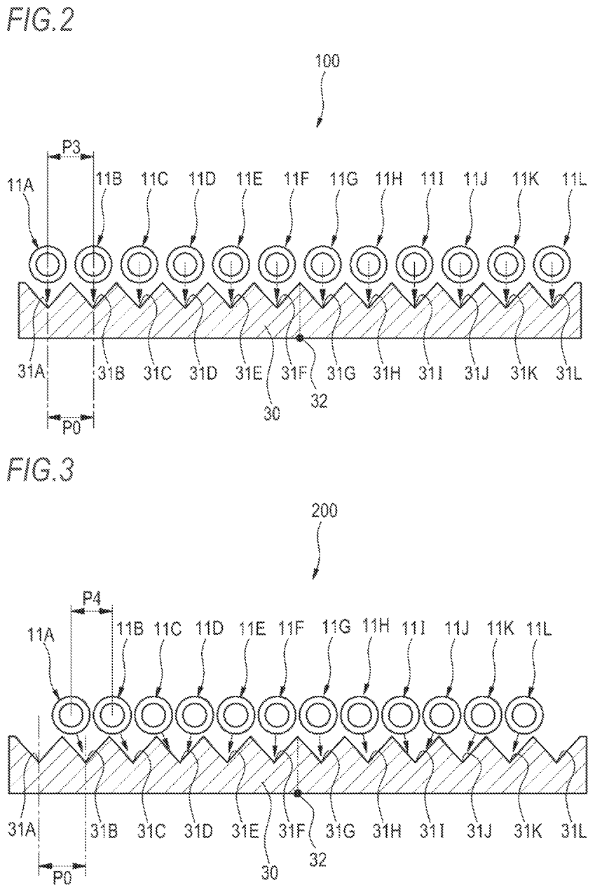

Next, fusion splicing of optical fiber ribbons will be described with reference to FIGS. 2 to 4.

When splicing the optical fiber ribbons, it is possible to collectively fuse and splice a plurality of optical fiber ribbons using a multi-fiber fusion splicer (not shown). As shown in FIGS. 2 to 4, the multi-fiber fusion splicer is provided with a V groove base 30 having a plurality of (twelve, in the example of FIGS. 2 to 4) V grooves 31A to 31L for arranging each of the optical fibers. These V grooves 31A to 31L are generally formed with a pitch P0 of 250 μm in accordance with the international standard for the diameter of the optical fiber. In order to collectively fusion splice a plurality of optical fibers, each optical fiber needs to be arranged one by one in order in each of the V grooves 31A to 31L of the V groove base 30.

FIG. 2 shows the fusion process of an optical fiber ribbon 100 of Reference Example 1, in which the optical fibers 11A to 11L having an outer diameter of approximately 185 μm are arranged in parallel with the distance P3 between centers of adjacent optical fibers being approximately 250 The pitch P0 of each of the V grooves 31A to 31L in the V groove base 30 of the multi-fiber fusion splicer is approximately 250 μm.

As shown in FIG. 2, during fusion splicing, the optical fibers 11A to 11L, with a predetermined length of coupling resin removed from the tips, are arranged above the V groove base 30. For example, the optical fibers 11A to 11L are arranged such that a center position of the optical fibers 11A to 11L in a direction in which the optical fibers 11A to 11L are arranged in parallel coincides with a center position 32 of the V groove base 30 in a direction in which the V grooves are arranged in parallel. In this state, a clamping lid (not shown) of the multi-fiber fusion splicer is closed, and the optical fibers 11A to 11L are pressed down from above by the clamping lid.

In the case of the optical fiber ribbon 100 configured as in Reference Example 1, since the distance P3 between centers is equal to the pitch P0 of the V grooves, each of the optical fibers 11A to 11L are arranged to face each of the V grooves 31A to 31L, respectively. As a result, the optical fibers 11A to 11L are pressed down substantially vertically and are seated one by one in order in the V grooves 31A to 31L.

FIG. 3 shows the fusion process of an optical fiber ribbon 200 of Reference Example 2, in which the optical fibers 11A to 11L having an outer diameter of approximately 185 μm are arranged in parallel with the distance P4 between centers of adjacent optical fiber ribbons being approximately 200 μm. In addition, the pitch P0 between the V grooves 31A to 31L in the V groove base 30 is 250 μm.

During fusion splicing, as shown in FIG. 3, the optical fibers 11A to 11L are arranged above the V groove base 30 such that the center positions 32 are aligned with each other in the same manner as in FIG. 2.

In the case of the optical fiber ribbon 200 configured as in Reference Example 2, since the distance P4 between centers of the optical fibers 11A to 11L is smaller than the pitch P0 of the V grooves 31A to 31L, the optical fibers 11A to 11L are arranged so as to gather above the center position 32 of the V groove base 30. For this reason, the optical fibers 11A to 11L are pressed down in the direction of the arrow along the groove walls of the V grooves, for example. Therefore, the optical fibers 11A to 11L cannot be seated in the V grooves 31A to 31L in order. For example, there are situations where the optical fibers may not be accommodated in the V grooves 31A, 31L, and the like at each end.

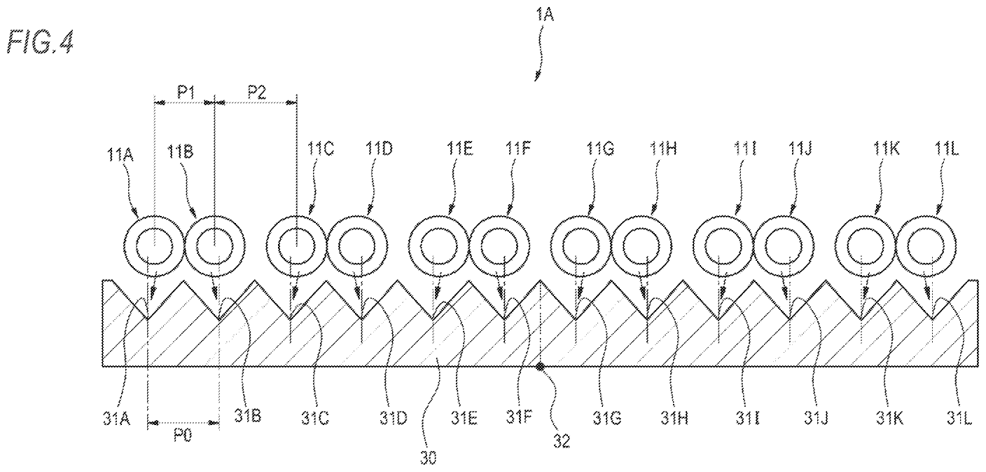

FIG. 4 shows a fusion process of the optical fiber ribbon 1A according to the first embodiment shown in FIG. 1. In addition, the pitch P0 between the V grooves 31A to 31L in the V groove base 30 is 250 μm. During fusion splicing, as shown in FIG. 4, the optical fibers 11A to 11L are arranged above the V groove base 30 such that the center positions 32 are aligned with each other in the same manner as in FIG. 2.

In the case of the optical fiber ribbon 1A according to the first embodiment, the distance P1 between centers (approximately 185 μm) of the adjacent optical fibers 11 in a state in which the adjacent optical fibers 11 are in contact with each other is smaller than the pitch P0 of the V grooves 31A to 31L. However, the distance P2 between centers (approximately 315 μm) between the adjacent optical fibers 11 in a state in which the bridge portions 21a are provided between the adjacent optical fibers 11 is larger than the pitch P0 of the V grooves 31A to 31L. For this reason, in the optical fiber ribbon 1A, because an average distance P between centers of the adjacent optical fibers 11 is approximately 250 μm, when pressed down by the clamping lid, they are guided in the direction of the arrows shown in FIG. 4 along the groove walls of the V grooves. As a result, the optical fibers 11A to 11L are accommodated one by one in the respective V grooves 31A to 31L in order.

In the above configuration, the optical fibers from which the coupling resin is removed are accommodated in the V grooves 31A to 31L, but, for example, the coating layer as well as the coupling resin may be removed such that only the glass fibers may be accommodated in the V grooves 31A to 31L.

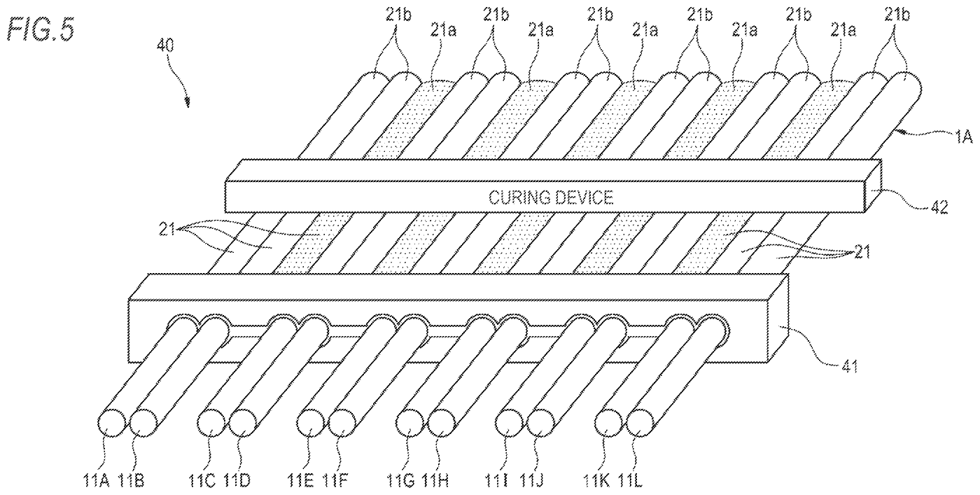

Next, a method for manufacturing the optical fiber ribbon 1A will be described with reference to FIG. 5.

First, the glass fiber 12 is drawn so that the diameter of the glass fiber 12 is approximately 125 μm, and the diameter including the second coating layer 14 is approximately 185 μm to manufacture the optical fibers 11A to 11L. Further, the optical fibers 11A to 11L may have a colored layer to enable identification.

The twelve optical fibers 11A to 11L are prepared and passed through a coating die 41 of a manufacturing apparatus 40 in a parallel state in which every two fibers are brought into contact with each other, and, in every two optical fibers, the optical fibers are spaced apart at a gap of a certain distance from each other. The coating die 41 is formed with holes at the die wire entry portion such that the gap between the optical fibers for every two fibers is approximately 130 μm when manufacturing the optical fiber ribbon 1A. The coating die 41 applies the coupling resin 21 to the outer circumferences of the optical fibers 11A and 11B, the optical fibers 11C and 11D, the optical fibers 11E and 11F, the optical fibers 11G and 11H, the optical fibers 11I and 11J, the optical fibers 11K and 11L, which are in contact with each other, and to the gaps between the optical fibers 11B and 11C, between the optical fibers 11D and 11E, between the optical fibers 11F and 11G, between the optical fibers 11H and 11I, and between the optical fibers 11J and 11K, which are spaced by the gap of a certain distance.

For example, when an ultraviolet curable resin is used as the coupling resin 21 for the optical fibers 11A to 11L coated with the coupling resin 21, the curing device 42 is irradiated with ultraviolet rays to cure the coupling resin 21. The bridge portions 21a are formed by curing the coupling resin 21 applied to the gaps between the optical fibers 11. By curing the coupling resin 21 applied to the outer circumferences of the optical fibers 11 in contact with each other, the outer circumference coating portion 21b is formed. As a result, the optical fiber ribbon 1A is manufactured such that the distance P1 between centers of the optical fibers 11A and 11B, the optical fibers 11C and 11D, the optical fibers 11E and 11F, the optical fibers 11G and 11H, the optical fibers 11I and 11J, and the optical fibers 11K and 11L is approximately 185 μm, the distance P2 between centers of the optical fibers 11B and 11C, the optical fibers 11D and 11E, the optical fibers 11F and 11G, the optical fibers 11H and 11I, and the optical fibers 11J and 11K is approximately 315 μm, and the average distance P between the centers of the adjacent optical fibers 11A to 11L is 220 μm or more and 280 μm or less.

In the manufacturing method described above, the coupling resin 21 forming the bridge portion 21a and the outer circumference coating portion 21b is applied by the coating die 41, but embodiments are not limited thereto. For example, first, only the coupling resin 21 forming the outer circumference coating portion 21b may be applied by the coating die 41, and then the coupling resin 21 forming the bridge portions 21a may be applied by an applicator such as a dispenser.

As described above, the optical fiber ribbon 1A includes the twelve fiber optical fibers 11A to 11L arranged in parallel, the coupling resin for coupling the optical fibers 11A to 11L, and the bridge portions 21a formed of the coupling resin. Then, the side surface of each optical fiber is arranged in a state of being spaced apart from or brought into contact with the side surface of another optical fiber adjacent thereto, and the bridge portion 21a is provided between the optical fibers 11 arranged in the state of being spaced apart from each other. The outer diameter of each optical fiber 11 is 185 μm or more and 195 μm or less, and the average distance P between centers of the adjacent optical fibers 11 is 220 μm or more and 280 μm or less. As a result, as shown in FIG. 4, when the related fusion splicer with the pitch of 250 μm of the V grooves 31A to 31L is used, the optical fibers 11A to 11L are arranged at positions corresponding to the V grooves 31A to 31L. Therefore, one optical fiber 11A to 11L can be accommodated in each of the V grooves 31A to 31L, respectively. As described above, according to the optical fiber ribbon 1A, the optical fiber 11 with a small diameter of 185 μm or more and 195 μm or less can be used, and by providing the bridge portion 21a between optical fibers in every two fibers, it can be easily mounted on V groove with a pitch of 250 μm of the related fusion splicer. Further, by using the optical fiber 11 with a small diameter, it is possible to make the width W of the bridge portion 21a relatively long, that is, approximately 130 μm, and increase the flexibility of the optical fiber ribbon 1A. Therefore, when mounting the optical fiber ribbon 1A on the optical fiber cable, for example, the bridge portions 21a can be bent such that the entire optical fiber ribbon 1A can be assembled and rolled for mounting. Therefore, the optical fiber ribbon 1A can be made suitable for high-density mounting.

Moreover, since the Young's modulus of the coupling resin 21 of the optical fiber ribbon 1A is in the range of 0.5 MPa or more and 200 MPa or less, the rigidity of the optical fiber ribbon 1A is in an appropriate range. Therefore, according to the optical fiber ribbon 1A, it is possible to have a structure having moderate flexibility, and it is possible to make the optical fiber ribbon suitable for high-density mounting.

Further, according to the optical fiber ribbon 1A, the coupling resin 21 includes a silicone-based release agent so that the coefficient of friction of the coupling resin 21 can be reduced. Therefore, for example, when the plurality of optical fiber ribbons 1A are mounted on an optical fiber cable, each optical fiber ribbon 1A is easily moved in the longitudinal direction. Therefore, it is possible to suppress an increase in transmission loss in a low-temperature environment in the mounted optical fiber cable. For example, the loss variation value of the loss temperature characteristic at −40° C. can be reduced to about ⅔ of that of the silicone-free optical fiber ribbon.

Further, according to the optical fiber ribbon 1A, by including a silicone-based release agent in the coupling resin 21, the adhesion between the outermost layer of the optical fiber 11 and the coupling resin 21 can be reduced, and the peeling strength can be less than N/mm. This improves the peelability of the coupling resin 21 from the outermost layer of the optical fiber 11, thereby facilitating the operation of single fiber separation of the optical fibers 11A to 11L.

Further, according to the optical fiber ribbon 1A, by using a cured product of the resin composition (resin including inorganic oxide particles) as the second coating layer 14 forming the outer coating of the optical fiber 11, the lateral pressure resistance of the optical fiber 11 can be enhanced. Therefore, when the optical fiber ribbon 1A is configured using such the optical fiber 11, it is possible to further suppress an increase in transmission loss that may occur upon mounting on an optical fiber cable, for example. Therefore, the optical fiber ribbon can be made more suitable for high-density mounting on the optical fiber cable. For example, the transmission loss at −40° C. can be improved to 0.3 dB/km compared to the maximum transmission loss of 0.5 dB/km of the optical fiber not using the resin composition.

Further, the bending loss can be improved by using an optical fiber having a bending loss at a wavelength of 1550 nm of 0.5 dB or less with a bending diameter of φ15 mm×1 turn, and 0.1 dB or less with a bending diameter of φ20 mm×1 turn, that is, ITU-T G. 657A2 equivalent optical fiber.

Further, the method for manufacturing the optical fiber ribbon 1A includes arranging twelve fiber optical fibers 11A to 11L with an outer diameter of 185 μm or more and 195 μm or less in parallel, arranging the twelve fiber optical fibers 11A to 11L in parallel such that a side surface of an optical fiber 11 is spaced apart from or brought into contact with a side surface of another optical fiber 11 adjacent thereto, passing the twelve optical fibers through the coating die 41 with an average distance between centers of the adjacent optical fibers 11A to 11L of 220 μm or more and 280 μm or less, and coating the coupling resin 21 on the outer peripheries of the spaced-apart portions and the plurality of optical fibers in contact, and curing the coupling resin 21 to provide the bridge portion 21a between the optical fibers 11 arranged so as to be spaced apart from each other. According to this method, it is possible to use an optical fiber with a small diameter of 185 μm or more and 195 μm or less and manufacture the optical fiber ribbon 1A that is easily mounted on V grooves with a pitch of 250 μm of the related fusion splicer and that is suitable for high-density mounting.

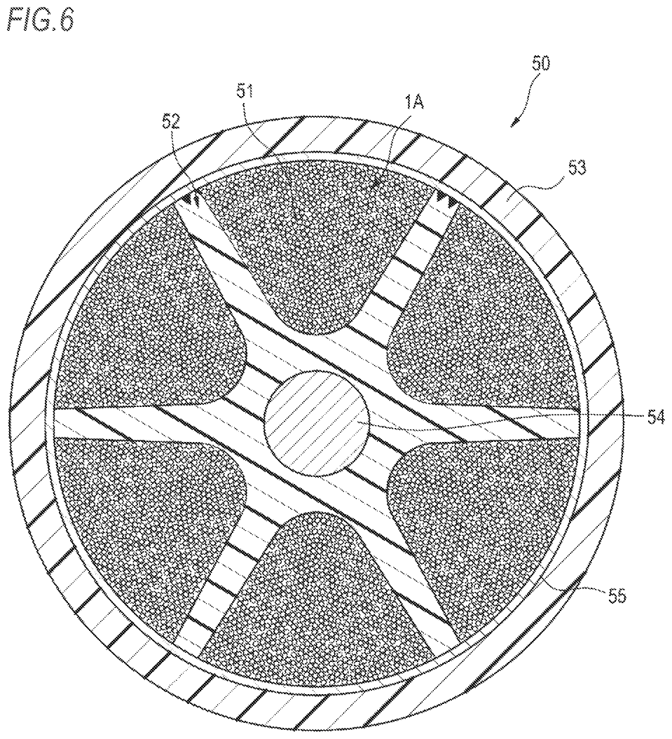

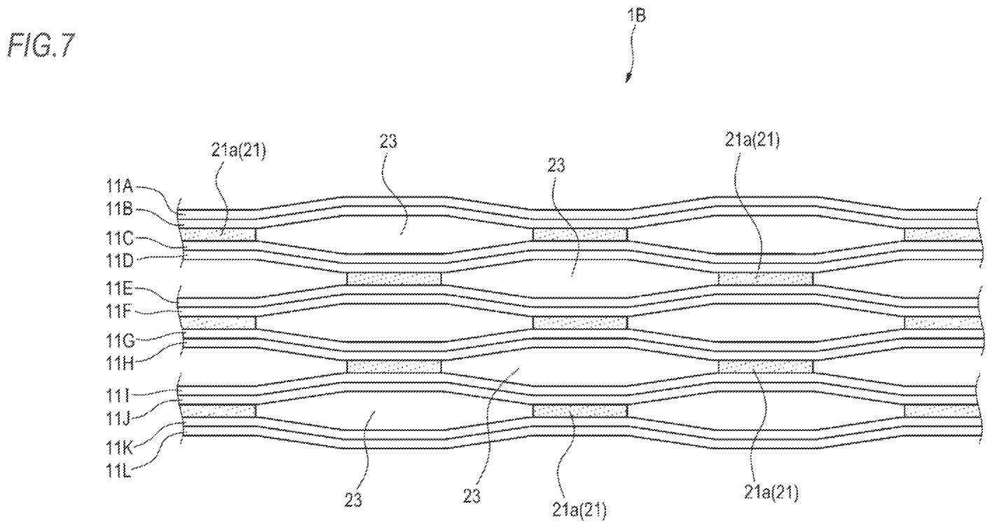

Next, an example of an optical fiber cable using the optical fiber ribbon 1A described above will be described with reference to FIG. 6.

FIG. 6 is a cross-sectional view of a slot type optical fiber cable 50 using the optical fiber ribbon 1A.

The optical fiber cable 50 has a slot rod 52 having a plurality of slot grooves 51, the plurality of optical fiber ribbons 1A, and a cable sheath 53. The optical fiber cable 50 has a structure in which the slot rod 52 having a tension member 54 in the center is provided with a plurality of radial slot grooves 51. In addition, the plurality of slot grooves 51 may be provided in a twisted shape such as a spiral shape or an SZ shape in the longitudinal direction of the optical fiber cable 50. Each of the slot grooves 51 accommodates a plurality of the optical fiber ribbons 1A that are rolled up from a parallel state and brought into a dense state. A press winding tape 55 is wound around the slot rod 52, and the cable sheath 53 is formed around the press winding tape 55.

The optical fiber cable 50 has an outer diameter of 34 mm, for example, and includes 6 slot grooves 51 and 3456 fiber optical fibers 11 in which 48 optical fiber ribbons 1A are accommodated in each slot groove 51. In this case, the fiber density calculated from the number of fibers of the optical fiber cable and the cross-sectional area of the optical fiber cable is 3.81 fibers/mm².

It is to be noted that the optical fiber cable is not limited to the slot type described above, and may be a slotless type optical fiber cable, for example.

According to the optical fiber cable 50 configured as described above, by using the optical fiber 11 with a small outer diameter of 185 μm or more and 195 μm or less, it is possible to mount the optical fiber ribbons 1A, which have a configuration that is easily mounted on the V groove of 250 μm pitch of the related fusion splicer, with a high density.

### Second Embodiment

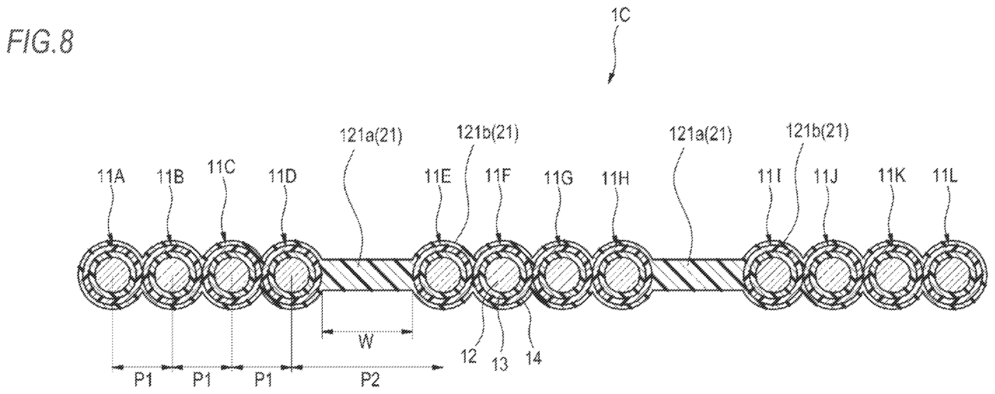

Next, an optical fiber ribbon 1B according to a second embodiment will be described with reference to FIG. 7. It is to be noted that the same reference numerals are assigned to the same configurations as those of the optical fiber ribbon 1A according to the first embodiment, and the description thereof will be omitted.

FIG. 7 shows a plan view of the optical fiber ribbon 1B. The optical fiber ribbon 1B is different from the optical fiber ribbon 1A according to the first embodiment in that the bridge portion 21a includes a split portion 23. The split portions 23 are intermittently formed in the longitudinal direction of the optical fiber ribbon 1B. In this example, the split portion 23 is formed in each bridge portion 21a, and the length of the split portion 23 in the longitudinal direction of the optical fiber ribbon 1B is longer than the length of the bridge portion 21a. The optical fiber ribbon 1B is an intermittently connected optical fiber ribbon in which the bridge portions 21a and the split portions 23 are provided intermittently in the longitudinal direction for every two optical fibers. The other configurations are the same as those of the optical fiber ribbon 1A. Note that the plan view of FIG. 7 shows the split portions 23 open in a parallel direction of the optical fiber 11.

According to the optical fiber ribbon 1B having the configuration described above, the split portions 23 are intermittently provided in the bridge portions 21a formed in every two fibers, thus allowing the optical fiber ribbon 1B to be easily deformed. Therefore, when the optical fiber ribbon 1B is mounted on the optical fiber cable, the optical fiber ribbon can be easily rolled and mounted, and thus can be made more suitable for high-density mounting. For example, in the optical fiber cable 50 (see FIG. 6) having 3456 optical fibers 11 in which 48 optical fiber ribbons 1B are accommodated in each slot groove 51, the mounting density calculated from the ratio of the slot grooves 51 (internal spaces) to the cross-sectional area of the optical fiber ribbon 1B is preferably 25% or more and 65% or less. When the mounting density is less than 25%, high-density mounting and reduction in diameter of the optical fiber cable 50 cannot be achieved. Moreover, when the mounting density is higher than 65%, the transmission loss increases in the optical fiber cable 50. By using the optical fiber ribbon 1B configured as described above, the mounting density can be kept within the preferable range described above.

In addition, since the bridge portion 21a can be easily torn from the split portion 23, the single fiber separation of the optical fiber 11 in the optical fiber ribbon 1B is facilitated.

In addition, with the configuration in which the bridge portion 21a is provided for every two fibers, it is possible to increase the width W of the bridge portion 21a compared to the configuration in which the bridge portion is provided between the fibers. Therefore, it is easy to form the split portion 23 in the bridge portion 21a of the optical fiber ribbon 1B.

Next, when various 12-fiber intermittently connected optical fiber ribbons are mounted on the optical fiber cable, the mounting density of the optical fiber ribbons to the optical fiber cable will be described with reference to Table 1. As described above, the mounting density is calculated from the ratio between the slot grooves 51 and the cross-sectional area of the optical fiber ribbon 1B. A slot type cable similar to the cable shown in FIG. 6 is used as the optical fiber cable.

TABLE 1

| | | | Cross-sectional | Mounting |
|---|---|---|---|---|
| | Type of Ribbon (12-fiber | Ribbon width × | area of fiber | density |
| | intermittent ribbon) | thickness (mm) | (mm²) | (%) |
| Example 1 | 250 μm fiber, without bridge | 3.1 × 0.3 | 0.786 | 67.2 |
| Example 2 | 200 μm fiber, without bridge | 2.51 × 0.225 | 0.463 | 39.6 |
| Example 3 | 200 μm fiber, with bridge in | 3.03 × 0.225 | 0.477 | 40.8 |
| | every 1 fiber | | | |
| Example 4 | 200 μm fiber, with bridge in | 2.94 × 0.225 | 0.544 | 46.5 |
| | every 2 fibers | | | |
| Example 5 | 185 μm fiber, with bridge in | 2.89 × 0.205 | 0.443 | 37.9 |
| | every 2 fibers | | | |

As shown in Table 1, in the 12-fiber intermittently connected optical fiber ribbon of Example 1, the optical fibers having an outer diameter of 250 μm are used, and the pitch between the fibers is about 250 μm without having a gap (bridge portion) between the fibers. In the case of Example 1, the cross-sectional area of the optical fiber ribbon is 0.786 mm² and the mounting density is 67.2%.

In the 12-fiber intermittently connected optical fiber ribbon of Example 2, the optical fibers with a small outer diameter of 200 μm are used, and the pitch between the fibers is approximately 200 μm without having a bridge portion between the fibers. In the case of Example 2, the cross-sectional area of the optical fiber ribbon is 0.463 mm² and the mounting density is 39.6%. Thus, using the optical fiber with a small diameter of 200 μm, it is possible to suppress the mounting density compared to the 12-fiber intermittently connected optical fiber ribbon of Example 1, for example. However, since the pitch between the fibers is 200 μm, it is difficult to mount the optical fibers in the V grooves (250 μm pitch) of the related fusion splicer, as in the case of the optical fiber ribbon 200 described with reference to FIG. 3.

In the 12-fiber intermittently connected optical fiber ribbon of Example 3, the optical fibers with a small outer diameter of 200 μm are used, and, in every fiber, the bridge portions are provided between the fibers, and the pitch between the fibers is 250 μm on average. In the case of Example 3, the cross-sectional area of the optical fiber ribbon is 0.477 mm² and the mounting density is 40.8%. Further, in the 12-fiber intermittently connected optical fiber ribbon of Example 4, the optical fibers with a small outer diameter of 200 μm are used, and, in every two fibers, bridge portions are provided between the fibers, and the pitch between the fibers is 250 μm on average. In Example 4, the cross-sectional area of the optical fiber ribbon is 0.544 mm² and the mounting density is 46.5%. Thus, in the 12-fiber intermittently connected optical fiber ribbons of Examples 3 and 4 using optical fibers with a small diameter of 200 for example, it is possible to suppress the mounting density compared to the 12-fiber intermittently connected optical fiber ribbon of Example 1. However, since the bridge portion is provided between the fibers in every one or two fibers, the mounting density is higher than the optical fiber ribbon in Example 2, which does not have a bridge portion and which uses the optical fibers with a small diameter of 200 μm.

The 12-fiber intermittently connected optical fiber ribbon of Example 5 is the optical fiber ribbon 1B of the second embodiment described above, which uses optical fibers having an outer diameter of 185 μm, and includes the bridge portion between the fibers in every two fibers so that the pitch between the fibers is 250 μm on average. In the case of Example 5, the cross-sectional area of the optical fiber ribbon is 0.443 mm² and the mounting density is 37.9%. Thus, using the optical fiber with an outer diameter of 185 μm, it is possible to further suppress the mounting density compared to the 12-fiber intermittently connected optical fiber ribbons of Example 2. In addition, by providing the bridge portion between the fibers in every two fibers, when mounting on the optical fiber cable, the fibers can be assembled and rolled by bending the bridge portions, and accordingly, an optical fiber ribbon suitable for high-density mounting can be obtained. Furthermore, by having the pitch of 250 μm between the fibers on average, it is easy to mount the optical fibers in the V grooves of the related fusion splicer.

### Third Embodiment

An optical fiber ribbon 1C according to a third embodiment will be described with reference to FIG. 8. It is to be noted that the same reference numerals are assigned to the same configurations as those of the optical fiber ribbon 1A according to the first embodiment, and the description thereof will be omitted.

FIG. 8 shows a cross-sectional view of the optical fiber ribbon 1C. The optical fiber ribbon 1C has the bridge portions 121a provided in every four fibers and is thus different from the optical fiber ribbon 1A according to the first embodiment which has the bridge portions 121a provided in every two fibers. In this example, the twelve optical fibers 11A to 11L are arranged such that, in every four fibers, a side surface of an optical fiber is spaced apart from or brought into contact with a side surface of another optical fiber adjacent thereto. In addition, the coupling resin 21 provided around the optical fibers 11 other than between the optical fibers 11 connected by a bridge portion 121a forms an outer circumference coating portion 121b that covers the outer circumference of the optical fiber 11, as in the first embodiment.

In the present example, the distance between centers of adjacent optical fibers 11 is formed such that the distance P1 between centers when the optical fibers 11 are in contact with each other is approximately 185 μm. In addition, the distance P2 between centers of the optical fibers 11 that are spaced apart from each other at a certain distance is approximately 445 μm. Therefore, in the optical fiber ribbon 1C, the average distance P ((3P1+P2)/4) between the centers of adjacent optical fibers 11 is 250 μm. In the case of this example, the width W of the bridge portion 121a (the width in the same direction as the parallel direction of the optical fibers) is approximately 260 μm. The other configurations are the same as those of the optical fiber ribbon 1A.

According to the optical fiber ribbon 1C having the above configuration, the same effects as those of the optical fiber ribbon 1A of the first embodiment can be obtained.

As described above, while the disclosure has been described in detail and with reference to specific embodiments thereof, it will be apparent to those skilled in the art that various changes and modifications can be made without departing from the spirit and scope of the disclosure. Further, the number, the position, the shape, and the like of the above-described constituent members are not limited to the above embodiments, and can be changed to a suitable number, position, shape, and the like for implementing the present disclosure.

### REFERENCE SIGNS LIST

1A to 1C, 100, 200: optical fiber ribbon
11 (11A to 11L): optical fibers
12: glass fiber
13: first coating layer
14: second coating layer
21: coupling resin
21a, 121a: bridge portion
21b, 121b: outer circumference coating portion
23: split portion
30: V groove base
31A to 31L: V groove
32: center position
40: manufacturing apparatus
41: coating die
42: curing device
50: optical fiber cable
51: slot groove
52: slot rod
53: cable sheath
54: tension member
55: ribbon

1. An optical fiber ribbon comprising a plurality of optical fibers arranged in parallel, a coupling resin for coupling the plurality of optical fibers, and a bridge portion formed of the coupling resin, wherein
the optical fibers are arranged such that a side surface of one optical fiber is spaced apart from or brought into contact with a side surface of another optical fiber adjacent to the one optical fiber,
the bridge portion is provided between the optical fibers arranged so as to be spaced apart from each other,
an outer diameter of the optical fiber is 185 μm or more and 195 μm or less, and
an average distance between centers of the optical fibers is 220 μm or more and 280 μm or less.

2. The optical fiber ribbon according to claim 1, wherein a number of the optical fibers arranged in contact is N, and N is a multiple of 2.

3. The optical fiber ribbon according to claim 1, wherein the coupling resin has a Young's modulus of 0.5 MPa or more and 200 MPa or less at room temperature.

4. The optical fiber ribbon according to claim 1, wherein split portions are intermittently formed in the bridge portion in a longitudinal direction of the optical fiber ribbon.

5. The optical fiber ribbon according to claim 1, wherein the coupling resin includes a silicone-based release agent.

6. The optical fiber ribbon according to claim 1, wherein a peeling strength between an outermost layer of the optical fiber and the coupling resin is less than 0.1 N/mm.

7. The optical fiber ribbon according to claim 1, wherein the optical fiber includes a glass fiber, a first coating layer covering a periphery of the glass fiber, and a second coating layer covering a periphery of the first coating layer,
the second coating layer includes a cured product of a resin composition including a base resin including a urethane acrylate oligomer or urethane methacrylate oligomer, a monomer having a phenoxy group, a photopolymerization initiator and a silane coupling agent, and hydrophobic inorganic oxide particles, and
content of the inorganic oxide particles is 1% by mass or more and 45% by mass or less with respect to a total amount of the resin composition.

8. The optical fiber ribbon according to claim 1, wherein the optical fiber has a bending loss of 0.5 dB or less at a wavelength of 1550 nm with a bending diameter of φ15 mm×1 turn, and 0.1 dB or less with a bending diameter of φ20 mm×1 turn.

9. A method for manufacturing an optical fiber ribbon comprising:
arranging a plurality of optical fibers having an outer diameter of 185 μm or more and 195 μm or less in parallel;
arranging the plurality of optical fibers in parallel such that a side surface of one optical fiber is spaced apart from or brought into contact with a side surface of another optical fiber adjacent thereto, passing the plurality of optical fibers through a die with an average distance between centers of the optical fibers of 220 μm or more and 280 μm or less, and coating a coupling resin on outer peripheries of the spaced-apart portions and the plurality of optical fibers in contact; and
curing the coupling resin to provide a bridge portion between the optical fibers arranged so as to be spaced apart from each other.
